(19) United States
(12) Patent Application Publication
(10) Pub. No.: US 2023/0196118 A1
(43) Pub. Date: Jun. 22, 2023

(54) ARCHITECTURE AGNOSTIC, ITERATIVE AND GUIDED FRAMEWORK FOR ROBUSTNESS IMPROVEMENT BASED ON TRAINING COVERAGE AND NOVELTY METRICS

(71) Applicant: THALES CANADA INC., Toronto (CA)

(72) Inventors: Simon CORBEIL-LETOURNEAU, Toronto (CA); Freddy LECUE, Toronto (CA); David BEACH, Toronto (CA)

(21) Appl. No.: 18/066,624

(22) Filed: Dec. 15, 2022

Related U.S. Application Data
(60) Provisional application No. 63/290,167, filed on Dec. 16, 2021.

(51) Int. Cl. G06N 3/091

(52) U.S. Cl. CPC G06N 3/091

(57) ABSTRACT

A method of improving robustness of a deep neural network (DNN), the method including: applying a coverage metric to a trained DNN based on a test set to determine test set adequacy; monitoring a performance of the trained DNN; based on the performance, applying new data to the trained DNN; applying a novelty metric to an output of the trained DNN based on the applied new data to identify a subset of the applied new data in response to determining whether new features are generated; and identifying the subset of the applied new data.

### PRIORITY

This application claims the priority of U.S. Provisional Application No. 63/290,167, filed Dec. 16, 2021, which is incorporated herein by reference in its entirety.

### BACKGROUND

A challenge slowing down the release of self-driving cars and other autonomous vehicles is related to the difficulty in certifying such intelligent agents and ensuring the public safety. The measurement of adequacy of testing (by test coverage) and the quantification of novelty in order to improve the robustness are insufficient elements for certification in deep learning.

### BRIEF DESCRIPTION OF THE DRAWINGS

Aspects of the present disclosure are best understood from the following detailed description when read with the accompanying figures. It is noted that, in accordance with the practice in the industry, various features are not drawn to scale. In fact, the dimensions of the various features are able to be increased or reduced for clarity of discussion.

FIG. 1 is a flowchart of a method of improving robustness of a deep neural network (DNN), in accordance with at least one embodiment.

FIG. 2 is a flowchart of a method for determining coverage metric values, in accordance with at least one embodiment.

FIG. 3 is a diagram of computation of a centroid, in accordance with at least one embodiment.

FIG. 4A is a diagram of construction of the training diversity distribution, in accordance with at least one embodiment.

FIG. 4B is a diagram of construction of the test diversity distribution, in accordance with at least one embodiment.

FIG. 5 is a diagram of computation of the coverage metric, in accordance with at least one embodiment.

FIG. 6 is a diagram of operation of the coverage metric, in accordance with at least one embodiment.

FIG. 7 is a diagram of a novelty metric associated to a diversity density probability distribution, in accordance with at least one embodiment.

FIG. 8 is a diagram of operation of the coverage metric, in accordance with at least one embodiment.

FIG. 9 is a flowchart of interaction of two metrics, in an iterative process in accordance with at least one embodiment.

FIG. 10 is a schematic view of a system for improving robustness of a deep neural network, in accordance with at least one embodiment.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows includes embodiments in which the first and second features are formed in direct contact, and also include embodiments in which additional features are capable of being formed between the first and second features, such that the first and second features are not in direct contact. In addition, reference numerals and/or letters are used in the various examples. This repetition is for the purpose of simplicity and clarity and does not in itself dictate a relationship between the various embodiments or configurations discussed.

Further, spatially relative terms, such as “beneath,” “below,” “lower,” “above,” “upper” and the like, are used herein for ease of description to describe one element or feature’s relationship to another element(s) or feature(s) as illustrated in the figures. The spatially relative terms are intended to encompass different orientations of the device in use or operation in addition to the orientation depicted in the figures. In one or more embodiments described herein, the apparatus is capable of being otherwise oriented (rotated 90 degrees or at other orientations) and the spatially relative descriptors used herein are likewise interpreted accordingly.

A safety-critical application is an application whose failure or malfunction may result in death or serious injury to people, loss or severe damage to equipment/property or environmental harm. A safety-critical application or system is rated Safety Integrity Level (SIL) 1-4. For a system to be rated as Safety Integrity Level (SIL) 4, the system provides demonstrable on-demand reliability, and techniques and measurements to detect and react to failures that may compromise the system’s safety properties. SIL 4 is based on International Electrotechnical Commission’s (IEC) standard IEC 61508 and EN standards 50126 and 50129. For a SIL 4 system, the probability of failure per hour ranges from 10⁻⁸/hour to 10⁻⁹/hour. Safety systems that are not required to meet a safety integrity level standard are referred to as non SIL. In one or more embodiments described herein, the disclosed systems target a Safety Integrity Level (SIL) 4.

The technical domains of one or more embodiments are deep learning, artificial intelligence, and certification of safety of systems. One or more embodiments address one or more of the following problems: (1) the performance evaluation problem of a deep neural network (DNN) in a neighborhood defined on a training manifold and/or (2) on the problem of improving the DNN robustness by extending the DNN operational domain by selecting new training data on the basis of the novelty content. The challenges include: 1) the evaluation of the performance of the trained DNN on a testing dataset which has the diversity of training distribution; and/or 2) the novelty quantification of new examples in order to select the most informative examples for retraining in order maximize the improvement of the DNN robustness to natural input.

Evaluation of the performance of a trained DNN uses the available dataset and splits the dataset in two parts: (1) the Training + Validation datasets and (2) the Testing dataset. The splitting is performed randomly in order to avoid selection bias. In at least some embodiments, the splitting is performed randomly. Both datasets are kept separated to avoid leak of information from one to the other. Because the training of a DNN uses an enormous amount of data, the testing set is often kept small, e.g., around 5%-20% of the total amount of data. Such small amount of data is likely to be a poor representation of the diversity of the learned features, which features have been learned from the training dataset.

An incomplete sampling of the underlying training distribution is likely to give poor evaluation of the performance of the trained DNN. If, prior to the training, splitting of the data cannot be separated differently, the resulting testing dataset is verified as a good sampling of the training distribution.

The coverage, by testing dataset, of the features learned from the training distribution is used to measure the quality of the test set. Thus, a good coverage score for the test set is an argument that the measured performance of the trained DNN is trustable. Many metrics are available to assess the test coverage. Two classes of metrics are identified: structural metrics and non-structural metrics.

Among the first class, a list of approaches is noted: DNC (DeepXplore’s Neuron Coverage), TKNC (Top-K Neuron Coverage), KMNC (K-Multisection Neurons Coverage), or SNAC (Strong Neuron Coverage). One structural approach is a modified condition/decision coverage (MCDC)-inspired neuron coverage metric.

In the second class, the likelihood-based surprise adequacy (LSA) and the distance-based adequacy (DSA) are the basis for the Likelihood-surprise coverage (LSC) and the distance-surprise coverage (DSC). LSC and DSC are approaches among the non-structural test coverage metrics. Non-structural coverage metrics provide better test effectiveness than structural coverage metrics.

In the second class, the likelihood-based surprise adequacy (LSA) and the distance-based adequacy (DSA) are the basis for the Likelihood-surprise coverage (LSC) and the distance-surprise coverage (DSC). LSC and DSC are approaches among the non-structural test coverage metrics. Non-structural coverage metrics provide better test effectiveness than structural coverage metrics. For example, structural coverage methods rely on testing specified behavior already encoded in the control flow. However, deep learning algorithms do not specify behavior and control flow. Most non-structural techniques are much more flexible and are based on two assumptions: 1) Two similar inputs (with respect to some human sense) to a Deep Learning (DL) system must lead to similar outputs; and 2) The more diverse a set of inputs is, more effective testing of a DL system is able to be performed.

The improvement of DNN robustness in response to out-of-distribution data is challenging. The diversification of the training dataset is a way to extend the operational domain, in order to improve the generalization ability of the system. A training dataset that includes adversarial attacks of diverse types for data augmentation has been used to improve the robustness. However, the quest of the optimal generalization capacity remains elusive. Prior methods fail to account for unexpected natural inputs causing erroneous behavior.

Embodiments described herein improve the robustness of a deep neural network (DNN). For example, at least one embodiment is used for the overall supervision of perception function chains, e.g., functions that detect objects, or read signals. In the context of object detection, at least one embodiment is used to provide a quantification of the degree to which an input to the overall detection function DNN is not familiar to the DNN, and thus, there may be less confidence or trust in the outputted detection indication. In at least one embodiment, improving the robustness of a deep neural network (DNN) is applicable to providing safety certification of autonomous vehicles before a product is released on the market. By improving the robustness of DNN, designers of critical-safety systems (based on Deep learning) are able to develop such systems with an expected level of safety.

In at least one embodiment, a guided selection of a new training dataset is used to tackle the problem. A poor selection of data includes many known features that dilute new or rare conditions, where the system is challenged by not-yet-learned features. To improve robustness, example feature redundancy is to be avoided.

In one or more embodiments described herein, the selection of data benefits from a guided selection based on novelty measurement in order to find new uncovered features. If these features and data are available, they are fed into the DNN for training in order to improve robustness.

One or more embodiments include a framework to improve iteratively the robustness of DNN. In at least one embodiment, two new metrics are implemented: 1) a coverage training-testing metric, and 2) a novelty content metric of data. In at least one embodiment, the coverage metric and novelty metric are agnostic of the neural network architecture. In at least one embodiment, a trained DNN without a specific architecture is used.

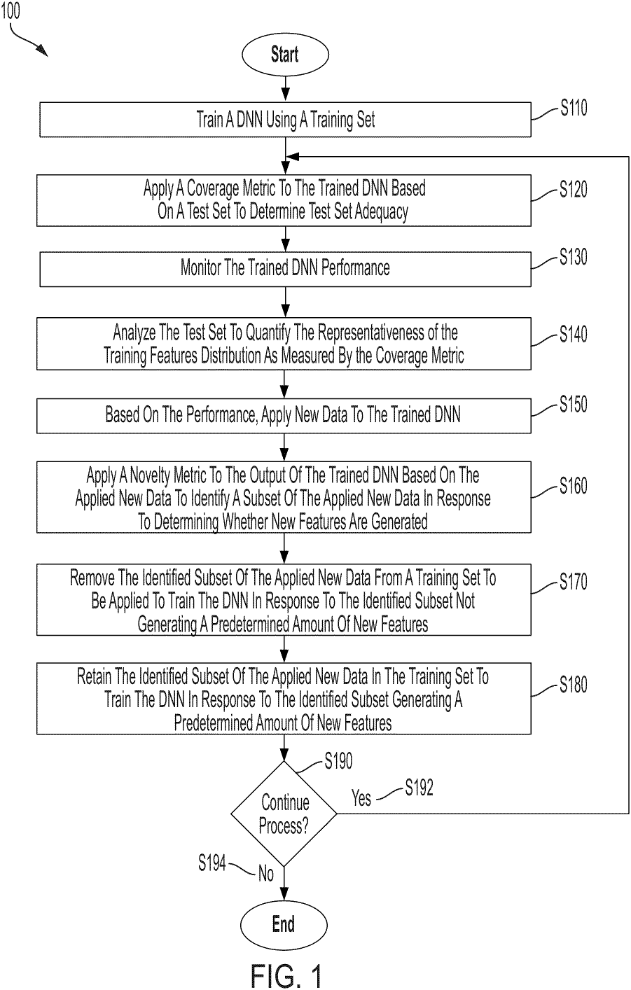

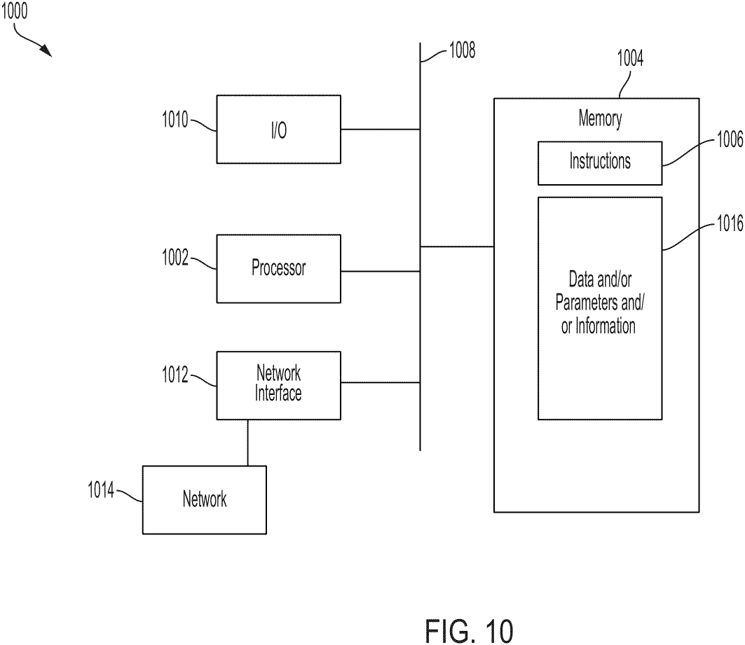

FIG. 1 is a flowchart 100 of a method of improving robustness of a deep neural network (DNN), in accordance with at least one embodiment. In at least one embodiment, the method is executed by a system 1000 (FIG. 10).

In FIG. 1, a DNN is trained using a training set in operation S110.

A coverage metric is applied to the trained DNN based on a test set to determine test set adequacy in operation S120. The coverage metric measures the test set adequacy and its ability to assess the performance of the pre-trained DNN. This coverage metric helps to modify test content in order to adjust its training distribution representativeness.

The trained DNN performance is monitored in operation S130.

The test set is analyzed to quantify its representativeness of the training features distribution as measured by the coverage metric in operation S140. In response to the DNN performing well, the extension of its operational domain will be guided by a novelty metric, which is applied on available data. The coverage metric indicates that the DNN is performing well in response to the training set activations diversity distribution being ‘close to’ or ‘in the neighborhood of’ the test set activations diversity distribution, e.g., a coverage value is at a predetermined level.

Based on the performance, new data is applied to the trained DNN to produce an activation pattern based on OOD (Out-Of-Distribution) probability values for the new data in operation S150. The activation pattern that is based on the OOD probability values for the new data represent a novelty value for the examples in the new data.

A novelty metric is applied to the output of the trained DNN based on the applied new data to identify a subset of the applied new data in response to determining whether new features are generated in operation S160. The novelty metric identifies the most novel examples, e.g., examples that contain the most new features. This information will help to identify the new dataset that will improve the robustness of the DNN. The novelty metric is used to verify that new data contains interesting new or learned features. The data do not need to be labeled for this novelty evaluation.

The identified subset of the applied new data is removed from a training set to be applied to train the DNN in response to the identified subset not generating a predetermined number of new features in operation S170.

The identified subset of the applied new data is retained in the training set to train the DNN in response to the identified subset generating a predetermined number of new features in operation S180. The new data are injected in the training dataset. To be properly preprocessed, data is labeled. The new set of data is fed into the DNN for retention and improvement of the DNN robustness. This set contains new data and/or data with badly learned features. The new features are selected based on engineering/safety considerations to improve the robustness, e.g., selected to extend the operational domain of the system.

A decision is made whether to return to continue the process in operation S190. In response to yes S192, the process returns to apply the coverage metric again in operation S120. In response to no S194, the process ends.

The flowchart 100 of FIG. 1, in accordance with at least one embodiment, presents the following advantages over a naive way of training a DNN. It allows a faithful evaluation of the performance of a trained DNN by evaluating the quality of the test set. This quality evaluation is performed by measuring the coverage of the training features distribution. In addition, the possibility to evaluate the novelty content of new examples is allowed to guide the selection of a new set of training examples with poorly covered features in order to accelerate the improvement of the robustness. The use of the selected coverage metric has the advantage of being computationally inexpensive. In addition, the information computed to evaluate the coverage metric is capable of being re-used to evaluate the novelty of new examples. Finally, a portable part of the information computed for the coverage value is capable of being used online to measure the novelty of incoming input, i.e., at a run time outside of the loop of testing and training. For example, in response to a tested system being released in the real world, the gathered information obtained from the training set is able to be used to gauge the level of novelty of an incoming input entering the system. The training set has a distribution of scores obtained by evaluation of the distance among the training examples with respect to the centroid. This distribution is tagged as normal. In response to the score of the new input at run-time being out of the normal distribution, a measure of novelty is determined by evaluating how probable the score of the new input is.

A large number of studies have been done to address the questions related to the improvement of robustness of a DNN. The most studied robustness topic is related to the problem of adversarial attack and the means to certify the adversarial robustness of a DNN. Many frameworks and methods are dedicated to this particular problem and these works focus on adversarial attacks and defense and the adversarial robustness to prevent such attacks. The adversarial robustness is a very specific formulation of the robustness problem which is a distinct topic of the more general robustness against out-of-distribution inputs encountered in natural operational conditions.

The natural inputs robustness is studied in many other papers and many frameworks give partial solution to it. DeepXplore, DeepTest and AIsafety are used to improve the robustness of DNN against new test inputs and corner case input that produce erroneous behavior.

Other approach frameworks appear to focus essentially on the adversarial robustness which is too specific a formulation of robustness. Their solutions are partially addressing the robustness problem. Also, other approaches appear to massively use the basic and traditional neuron coverage as a guide to lead the improvement of robustness. Basic neural coverage criterion is misleading as reported. Counting the number of neurons exercised by the examples of a given test set is a rough evaluation of the number of useful neuron and a naive translation of classical software testing strategy. The neural coverage information doesn’t give any insight about the activation configuration of neurons in a given layer. Both the location and the pattern of activation diversity are lost in response to using this metric. No clustering based on erroneous activation pattern is extracted from this metric. In addition, no clear interest has been dedicated to the novelty level of new example in order to select the best retraining data set to improve the ability of a DNN to its generalization. At least one approach focuses on the neuron importance analysis, while other approaches do not guide the robustness improvement by using the novelty content, but instead look for a corner case and provide a solution to the associated erroneous behavior. The other approaches exposed methods that do not provide guarantees of preventing erroneous behavior from occurring in response to new natural inputs that are fed to the networks. The adversarial attacks are a limited and specialized set of inputs and cannot be taken as a good and exhaustive representation of potentially dangerous or erroneous natural inputs. These frameworks indeed improved the robustness of the DNN, but none of them allowed identification of which example contained new features to inject into the training set.

The other approaches show the effect of different frameworks addressing the problems of improving the robustness in a more general way. These frameworks involve modules that evaluate the test coverage. At least some of the other approaches appear to use a basic definition of structural neural coverage metric which have been criticized to be not positively correlated to many properties of neural networks such as defect detection. In fact, many other studies highlight the fact that structural neuron coverage are less performant than non-structural neuron coverage metrics.

In at least some other approaches, coverage metrics based on surprise adequacy are studied to evaluate the test set representativeness. An alternative method called Importance-Driven coverage is usable to evaluate the quality of the test set. The surprise adequacy seems to be computationally expensive and difficult to scale to large datasets. On the other hand, the Importance-Driven coverage seems an interesting strategy for analyzing the test set coverage; however, this method involves many intermediate steps to compute the coverage metrics and a limited number of neurons are kept.

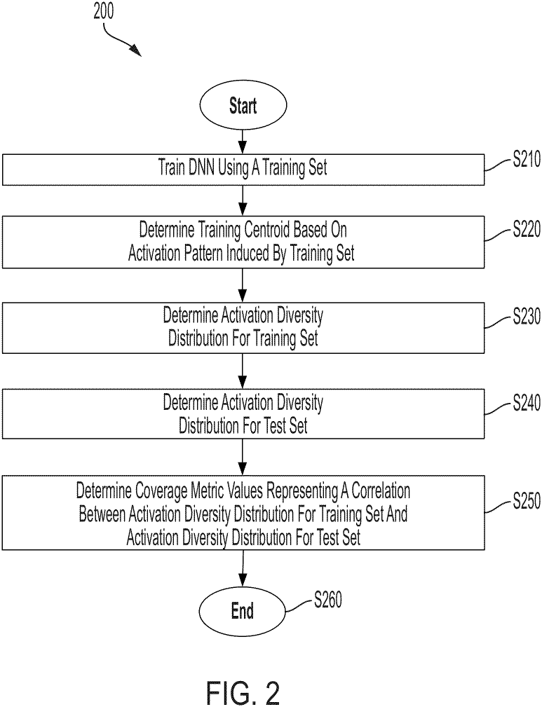

FIG. 2 is a flowchart 200 of a method for determining coverage metric values, in accordance with at least one embodiment. In at least one embodiment, the method is executed by a system 1000 (FIG. 10).

In FIG. 2, a DNN is trained using a training set in operation S210. To train the DNN, training data is put into the input layer, where neurons assign a weighting to the input based on the task being performed. In a DNN, there are additional layers between the input layer and the output.

A training centroid is determined based on an activation pattern induced by the training set in operation S220. The training centroid is computed by averaging over the training examples the activation pattern induced thereby. The centroid is a tensor having the following dimensions: (N₁) x (N₂) x (...) x (Nₙ), where Ni is the number of activation values kept in the selected neuron layer (i).

An activation diversity distribution is determined for the training set in operation S230. The training set activation diversity distribution is computed by comparing the training centroid with values of the activation pattern induced by one or more training examples. The diversity distribution is a mapping on the multidimensional activation space to a scalar probability density distribution dtrain(x)=dp(x)/dx, where x is a measure of the distance between the centroid and values in the training set activation pattern.

An activation diversity distribution is determined for a test set in operation S240. The test set activation diversity is computed by comparing, as with the training set, the activation pattern induced by the testing examples with the training centroid. This induced scalar probability distribution of test set diversity is noted dtest(x)=dp(x)/dx, where x is the distance between the training centroid and a given test example.

Coverage metric values representing a correlation between activation diversity distribution for training set and activation diversity distribution for test set are determined in operation S250. In response to the test set having too low of a coverage value, the application of the coverage metric stops, and recommendations are formulated to improve the test set. In response to the test set having a high enough coverage value, DNN performances are evaluated. A coverage value of 0 means that there is no overlap between two distributions, and a coverage of 1 is a full overlap of the two distributions. The possible coverages values are restricted to the interval between 0 and 1. There is no predefined threshold for whether a coverage value is too low, but is based on judgement and experience of the person performing the validation and testing, and the determination of such a threshold is highly system dependent.

The test and training set diversity density distributions, respectively dtest and dtrain, are fed to the coverage metrics which is an approximate integral of min(dtest, dtrain)(x) over the x values. The coverage metric is based on the activation patterns extracted directly from the training distribution. This metric is applicable without regard to the type of input and output. The coverage metric measures to what extent the diversity of activation pattern exercised by training distribution is ‘close to’ or ‘in the neighborhood of’ the pattern diversity of the test set. The coverage metric also takes into account the occurrence frequency of pattern to avoid over or under sampling of patterns which helps to avoid introducing bias into the assessment of DNN performance. The coverage metric is applied to unlabeled data.

The computation cost of this metric is linear with the total number of data (the training set + the test set), in contrast with the surprise adequacy metric in which costs scale quadratically with the amount of data. One or more of the novelty metric and the coverage metric use the diversity of activation pattern. This fact reduces further the computation cost. The diversity of patterns dictated by the training distribution is the information that is used to define what is considered as unusual; not likely to come from previously shown training distribution. Also, there is no need of labeled data to measure novelty. This metric is applied in an unsupervised way. However, the retraining of the DNN using the augmented training set still needs labels for the new example.

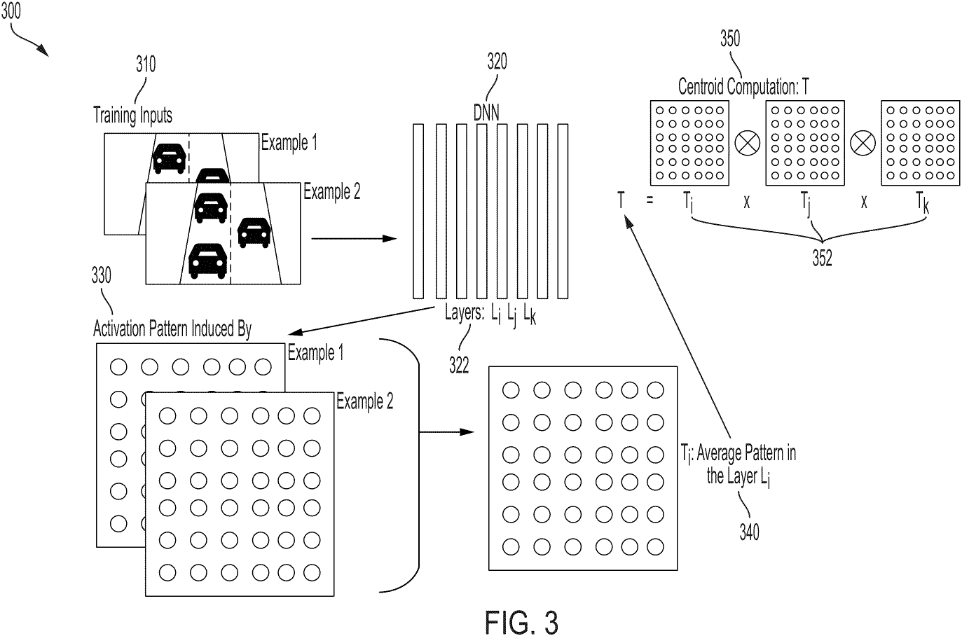

FIG. 3 is a diagram of computation of a centroid 300, in accordance with at least one embodiment.

In FIG. 3, training inputs 310 are identified. The training inputs 310 include Example 1 and Example 2. Many different examples are used to train a DNN.

The training inputs 310 are provided to a DNN 320. DNN 320 includes a plurality of neuron layers 322, e.g., Lᵢ, Lⱼ, Lₖ, or the like. A DNN includes an input layer of nodes that receives the training inputs. To train the DNN, training data is put into the input layer, where neurons assign a weighting to the input based on the task being performed. In a DNN, there are additional layers between the input layer and the output.

DNN 320 produces an activation pattern 330 induced by the training samples, e.g., Example 1 and Example 2. The activation pattern is taken from selected neuron layers. DNN 320 accepts the training inputs 310 and applies an activation function that is used to define the output of neuron layers of the DNN 320. Based on the activation function, DNN 320 uses the activation function to generate the activation pattern 320.

An average pattern for the layers 340 is determined. The average of the activation patterns of a given layer, Tᵢ, are averaged over the training set.

The average patterns for the layers 340 are used for centroid computation 350. The activation centroid tensor T 350 is generated by tensor multiplying the resulting arrays of the average pattern for the different layers 352.

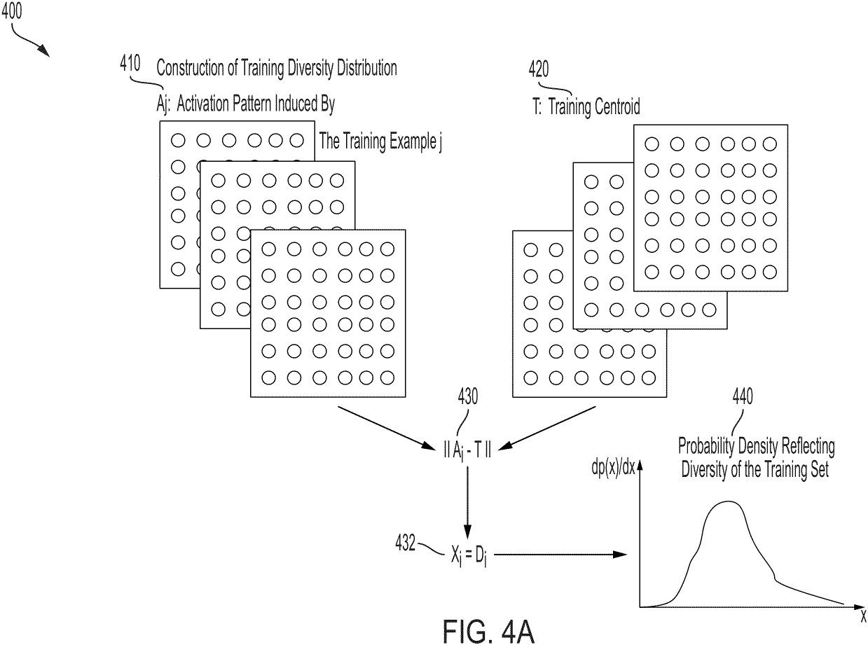

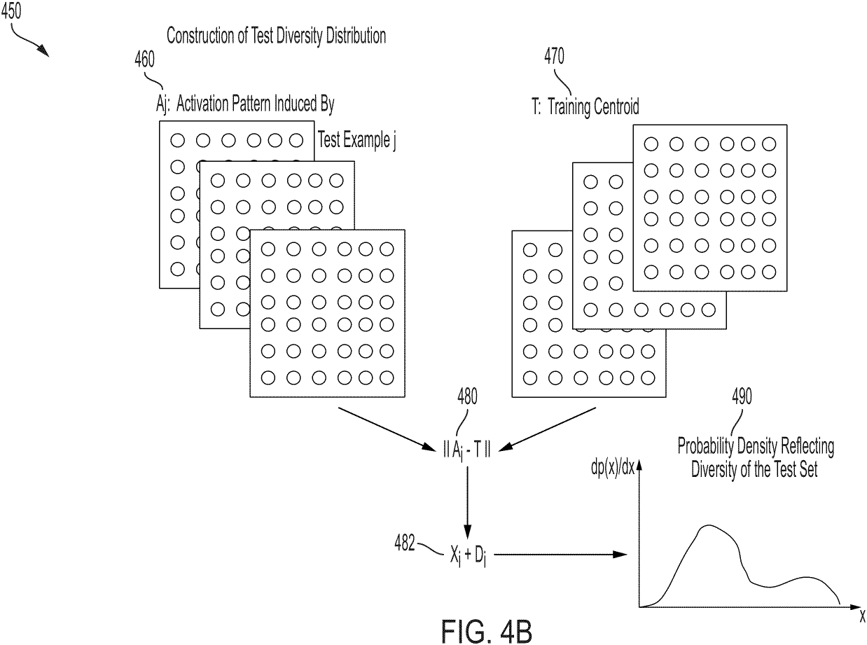

FIG. 4A is a diagram of construction of the training diversity distribution 400, in accordance with at least one embodiment.

In FIG. 4A, the Euclidean distance (also referred to as computed values) 432 is computed 430 between the training centroid 420 and the activation pattern Aⱼ 410 induced by the training example j. As described above, the training centroid is determined based on an activation pattern induced by the training set. The training centroid is computed by averaging the activation pattern induced by the training examples per layer.

A probability density reflecting diversity of the training set 440 is determined based on the computed values 432. The densities probability distribution, dp(x)/dx associated with the distances, x, are plotted in the graph of the probability density reflecting diversity of the training set 440.

FIG. 4B is a diagram of construction of the test diversity distribution 450, in accordance with at least one embodiment.

In FIG. 4B, the Euclidean distance 482 is computed 480 between the training centroid 470 and the activation pattern Aⱼ 460 induced by the test example j. As described above, the training centroid is determined based on an activation pattern induced by the training set. The training centroid is computed by averaging over the training examples the activation pattern induced by the test example j. Similar to the description of FIG. 3, a DNN accepts the test examples and applies an activation function that is used to define the output of neuron layers of the DNN. Based on the activation function, the DNN uses the activation function to generate activation pattern 460.

A probability density reflecting diversity of the test set 490 is determined based on the computed values of the Euclidean distances 482. The densities probability distribution, dp(x)/dx associated with the distances, x, are plotted in the graph of the probability density reflecting diversity of the test set 490.

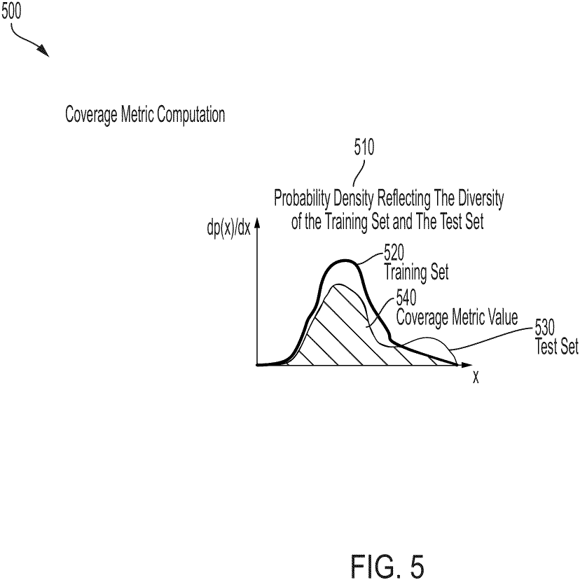

FIG. 5 is a diagram of computation of the coverage metric 500, in accordance with at least one embodiment.

In FIG. 5, the probability density reflecting the diversity of the training set and the probability density reflecting the diversity of the test set 510 are plotted. In FIG. 5, the probability density reflecting diversity of the training set 520 is plotted. Also plotted is the probability density reflecting diversity of the training set 530. The coverage metric values 540 of the training set by the test set is given by the integral of the minimum value of the density probability distribution associated to the training and the testing sets.

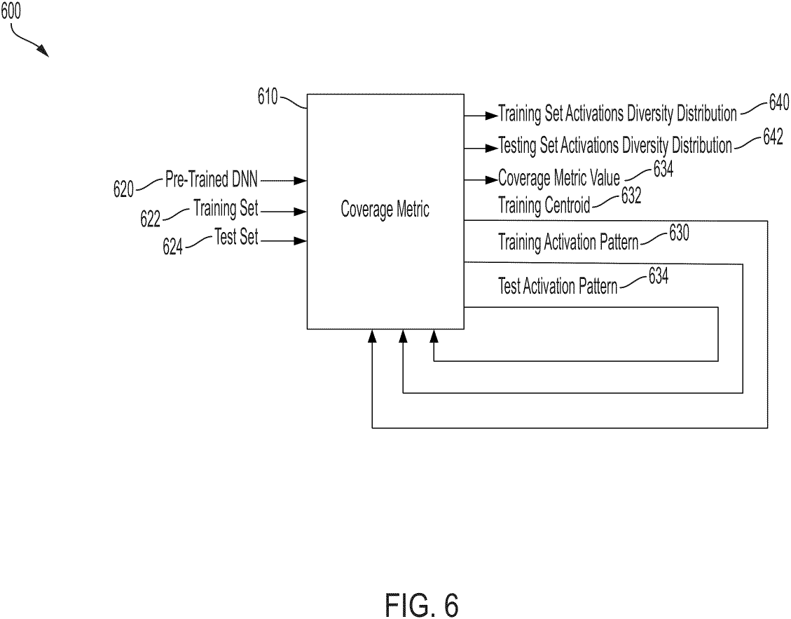

FIG. 6 is a diagram of operation of the coverage metric 600, in accordance with at least one embodiment.

In FIG. 6, the coverage metric 610 receives pre-trained DNN 620, a training set 622, and a test set 624 as inputs. The coverage metric 610 generates a training activation pattern 630 induced by the training set 622. The coverage metric 610 determines an average pattern in the layers of the training activation pattern 630 induced by the training set 630. The coverage metric 610 generates a training centroid 632 based on the average pattern in the layers of the training activation pattern 630 induced by the training set 630. The training centroid 632 is a tensor of the following dimensions: (N₁) x (N2) x (...) x (Nₙ), where Nᵢ is the number of activation values kept in the selected neuron layer (i).

The coverage metric 610 generates a training set activations diversity distribution 640 based on the training activation pattern 630 induced by the training set 630, and the training centroid 632. The training set activation diversity distribution 640 is a mapping on the multidimensional activation space to a scalar probability density distribution dtrain(x) = dp(x)/dx, where x is a measure of the distance between the centroid and a given example.

The coverage metric 610 generates a test activation pattern 634 induced by the test set 642. The coverage metric 610 then generates a test set activations diversity distribution 642 based on the test activation pattern 634 induced by the test set 624, and the training centroid 632.

The test set activations diversity distribution 642 is computed by comparing the test activation pattern 634 induced by testing set 624 with the training centroid 634. The induced scalar probability distribution of test set diversity 632 is noted dtest(x)=dp(x)/dx, where x is the distance between the training centroid and a given test example.

The training and test set diversity density distributions 640, 642, respectively dtest and dtrain, are used by the coverage metrics to generate the coverage metric value 650, which is an approximate integral of min(dtest, dtrain)(x) over the x values.

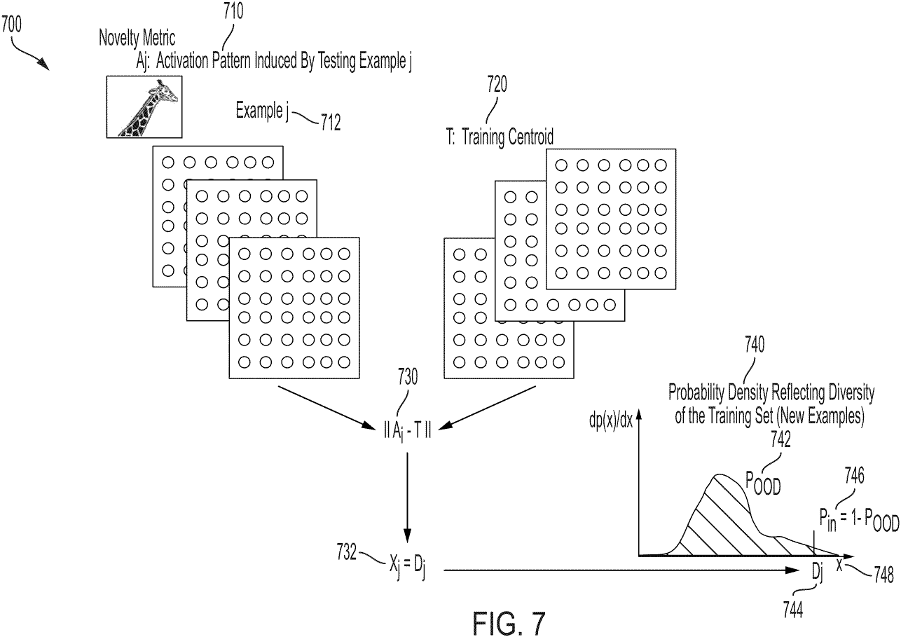

FIG. 7 is a diagram of a novelty metric 700 associated to a diversity density probability distribution, in accordance with at least one embodiment.

In FIG. 7, activation pattern, Aⱼ 710, is induced by testing example j 712, which is a new example.

The Euclidean distance 732 is computed 730 between the training centroid 720 and the activation pattern Aⱼ 710 induced by new example j 712. A probability density reflecting diversity of the training set 740 is determined based on the computed values 732. The densities probability distribution, dp(x)/dx associated with the distances, x, are shown in the graph of the probability density reflecting diversity of the training set 740.

In FIG. 7, the computation of the distance between new example j 712 and the training centroid 720 is located in the training diversity distribution 740. The proportion of training examples that have a lower distance than the considered new example, Dⱼ 744, is the probability that this new example j 712 is not part of the training distribution (P_{OOD}) 742 (OOD: out-of-distribution). P_{OOD} is represented by the shaded portion under the graph up to Dⱼ 744. The shaded portion from Dⱼ 744 to x 748 is the probability that the considered example is resulting from the training example: Pᵢₙ = 1 - P_{OOD} 746. In addition, the novelty metric is used to monitor online inputs that present a potentially dangerous or erroneous result because of the novelty content is consider as OOD (out-of-distribution).

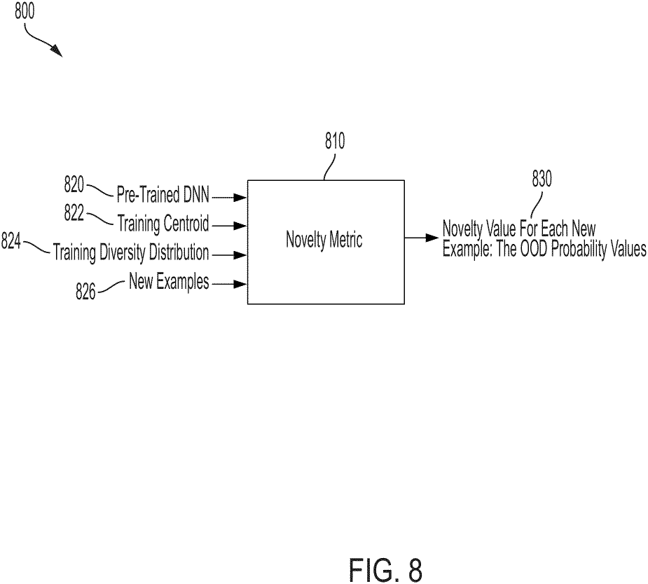

FIG. 8 is a diagram of operation of the coverage metric 800, in accordance with at least one embodiment.

In FIG. 8, the novelty metric 810 receives pre-trained DNN 820, a training centroid 822, training diversity distribution 824, and new examples 826. The novelty metric 810 generates as an output a novelty value for the new examples: the OOD probability values 830.

In FIG. 8, the new examples 826 are fed into DNN 820 and the associated activation patterns induced by the new examples 826 are extracted. The activation patterns are compared to the training centroid 822 to compute the distance separating the new examples behavior and the training centroid 822. OOD (Out-Of-Distribution) probability values 830 are associated with the new examples 826 by comparing the distance previously computed for the training diversity distribution. The OOD probability values 830 are obtained by integrating over the density distribution between 0 and the distance obtained for a given example.

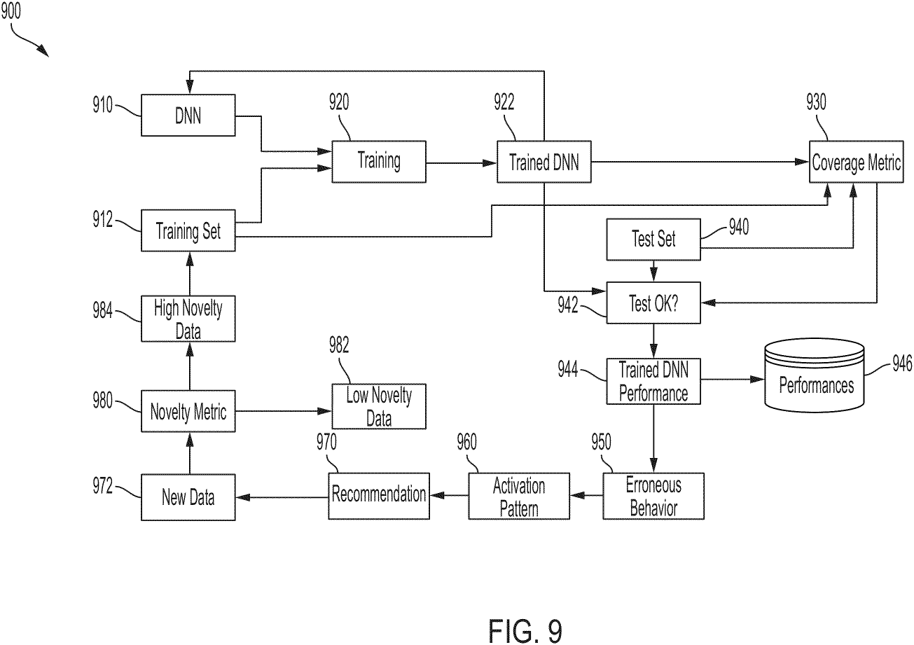

FIG. 9 is a flowchart of interaction of two metrics in an iterative process 900, in accordance with at least one embodiment.

In FIG. 9, a DNN 910 and a training set 912 are input to training 920. The result is a trained DNN 922. A coverage metric 930 receives the output of the trained DNN 922 and the training set 912. A test set 940 is also provided to the coverage metric 930. The test set 940 is analyzed 942 to quantify a coverage value is at a predetermined level represent a strong correlation between the training set activations diversity distribution and the test set activations diversity distribution as measured by the coverage metric 930.

The trained DNN performance 944 is stored in a performances database 946. Erroneous behavior 950 is determined based on the trained DNN performance 944. An activation pattern 960 is generated and recommendations 970 are made to select new data 972. The training set includes examples which are difficult to learn and which induce error. The training sets are characterized by activation patterns, and a recommendation is based on such an activation pattern. Other examples that share such activation pattern are able to be added to the training set to help the learning. These new recommended examples are able to be selected in another data set, or generated by perturbing the initial example with selected transformations, such as adding noise, applying random rotation, modification of the contrast, or the like.

The new data 972 is input to the novelty metric 980. Trained DNN 922 accepts the test set 940 and applies an activation function that is used to define the output of neuron layers of the trained DNN 922. Based on the activation function, the trained DNN 922 uses the activation function to generate the activation pattern 960. Low novelty data 982 is removed or withheld from training set 912. High novelty data 984 is retained and input to the training set 912 to further train the DNN in response to the identified new data 972. The processing continues to cycle through in an iterative manner. The novelty threshold is a matter of validation and testing criterion that is not predetermined. The novelty of an example is tied to the probability of being out-of-distribution (ood). The novelty (the P_{ood}(D)) is equal to 1 - Pᵢₙ(D) where Pᵢₙ(D) is the fraction of the training set that has a distance (D) equal or higher then D.

Even if the method is architecture agnostic, the activation pattern 900 in FIG. 9 is applied in conjunction with an extraction on a set of limited number of layers to minimize the cost associated with the computation. The extraction of patterns is straightforward for fully connected layer and is generalized to a convolutional layer. However, the activation pattern associated with convolutional layers will be more expensive. In at least one embodiment, multi-modal inputs are used, but for more meaningful results the different input modes are considered separately in the analyses of the coverage and the novelty content.

The iterative process 900 representing the interaction of the two metrics in FIG. 9 improves the robustness of DNN 910. The coverage metric 930 and the novelty metric 980 are used for deep learning applications and provide an advantage for certification of DNNs. At least one expected industrial application is in autonomous train, a monorail, a tram, a magnetic guided vehicle, a railcar, a watercraft (ships, boats), amphibious vehicles (screw-propelled vehicle, hovercraft), amphibious vehicles (screw-propelled vehicle, hovercraft), an aerospace vehicle (airplanes, helicopters), spacecraft, a rover, a drone, a self-driving car, or other motor vehicle (motorcycles, cars, trucks, and buses), or other autonomously controlled vehicle. Autonomous vehicles use mechatronics, artificial intelligence, and/or multi-agent systems to assist a vehicle’s operator. In at least one embodiment, a vehicle includes a machine that transports people and/or cargo. In at least one embodiment, a vehicle also includes a wagon, and a bicycle. Land vehicles are classified broadly by what is used to apply steering and drive forces against the ground: wheeled, tracked, railed, or skied, such as is detailed in ISO 3833-1977 standard. In at least one embodiment, a vehicle is restricted to a constrained path such as a roadway or rail. In some embodiments, vehicle 104 is an autonomous vehicle.

In at least one embodiment, safe operation of a vehicle includes detecting potentially hazardous objects or objects to avoid, and, if needed, taking action in response to detecting such an object. Vehicle control is achieved through various combinations of human and automated activity, and in some cases is fully automated. Safety is particularly important for vehicles that operate on guideways, e.g., trains that run on tracks. Sensors and safety systems are used to improve safety of operators and persons working on or a vehicle, e.g., near train tracks during rail operations. Integrating sensors and safety systems increase the safety of operation while lowering the operational cost of vehicle movement, and expanding the flexibility of routing vehicles along

Vehicles that travel over a wide variety of locations and environments face challenges; determining the current location of the vehicle, tracking the location of the vehicle as the vehicle moves, and accurately determining the speed of the vehicle.

In at least one embodiment, Deep Neural Networks (DNN), such as DNN 910 in FIG. 9, is a layered neural network. DNN includes convolution neural networks (CNN), recurrent neural networks (RNN), and Multi-Layer Perceptrons (MLP). DNN is used in machine language translation, image search tools, medical diagnosis, computer vision, and self-driving vehicles. DNNs rely on sophisticated machine learning models trained on massive datasets with respect to scalable, high-performance infrastructures, creating and using decision systems.

The coverage metric 930 is based on the activation pattern to compute the overlap of the training and test set features distribution. The coverage metric 930 is determined as the integral of the min(dtrain(x), dtest(x)) over the interval of possible values of x: the Euclidean distance between the training centroid and the examples of a dataset. The novelty metric 980 is determined as the probability of being out-of-distribution, which probability is computed on the basis of the training density distribution and the location, in this distribution, of the compared example.

FIG. 10 is a schematic view of a system 1000 for improving robustness of a deep neural network, in accordance with at least one embodiment.

In FIG. 10, system 1000 includes a hardware processor 1002 and a non-transitory, computer readable storage medium 1004 encoded with, i.e., storing, the computer program code 1006, i.e., a set of executable instructions. The processor 1002 is electrically coupled to the computer readable storage medium 1004 via a bus 1008. The processor 1002 is also electrically coupled to an I/O interface 1010 by bus 1008. A network interface 1012 is also electrically connected to the processor 1002 via bus 1008. Network interface 1012 is connected to a network 1014, so that processor 1002 and computer readable storage medium 1004 are capable of connecting to external elements via network 1014. The processor 1002 is configured to execute the computer program code 1006 encoded in the computer readable storage medium 1004 in order to cause system 1000 to be usable for performing a portion or all of the processes or methods in accordance with one or more of the embodiments as described above.

In some embodiments, the processor 1002 is a central processing unit (CPU), a multi-processor, a distributed processing system, an application specific integrated circuit (ASIC), and/or a suitable processing unit.

In some embodiments, the computer readable storage medium 1004 is an electronic, magnetic, optical, electromagnetic, infrared, and/or a semiconductor system (or apparatus or device). For example, the computer readable storage medium 1004 includes a semiconductor or solid-state memory, a magnetic tape, a removable computer diskette, a random access memory (RAM), a read-only memory (ROM), a rigid magnetic disk, and/or an optical disk. In some embodiments using optical disks, the computer readable storage medium 1004 includes a compact disk-read only memory (CD-ROM), a compact disk-read/write (CD-R/W), and/or a digital video disc (DVD).

In some embodiments, the storage medium 1004 stores the computer program code 1006 configured to cause system 1000 to perform a method as describe herein. In some embodiments, the storage medium 1004 also stores information used for performing the method as well as information generated during performing the method, such as data and/or parameters and/or information 1016 and/or a set of executable instructions 1006 to perform the processes or methods in accordance with one or more of the embodiments as described above.

System 1000 includes I/O interface 1010. I/O interface 1010 is coupled to external circuitry. In some embodiments, I/O interface 1010 includes a keyboard, keypad, mouse, trackball, trackpad, and/or cursor direction keys for communicating information and commands to processor 1002.

System 1000 also includes network interface 1012 coupled to the processor 1002. Network interface 1012 allows system 1000 to communicate with network 1014, to which one or more other computer systems are connected. Network interface 1012 includes wireless network interfaces such as BLUETOOTH, WIFI, WIMAX, GPRS, or WCDMA; or wired network interface such as ETHERNET, USB, or IEEE-1394. In some embodiments, the method is implemented in two or more systems 1000, and information is exchanged between different systems 1000 via network 1014.

System 1000 is configured to receive information through I/O interface 1010. The information is transferred to processor 1002 via bus 1008.

In at least one embodiment, a method of improving robustness of a deep neural network (DNN) includes applying a coverage metric to a trained DNN based on a test set to determine test set adequacy, and monitoring a performance of the trained DNN. Based on the performance, new data is applied to the trained DNN. A novelty metric is applied to an output of the trained DNN based on the applied new data to identify a subset of the applied new data in response to determining whether new features are generated. The subset of the applied new data is identified.

The identified subset of the applied new data is removed from a training set to be applied to train the DNN in response to the identified subset not generating a predetermined amount of the new features. The identified subset of the applied new data is retained in a training set to be applied to train the DNN in response to the identified subset generating a predetermined amount of the new features. The applying the coverage metric further includes training the DNN using a training set, generating a training activation pattern induced by the training set, and determining a training centroid based on the activation pattern induced by the training set. A first distance between the training centroid and values of the training activation pattern induced by the training set is determined. Based on the first distance, a training activation diversity distribution for the training set is generated. A test activation pattern induced by the test set is generated. A second distance between the training centroid and values of the test activation pattern induced by the test set is determined. Based on the second distance, a test activation diversity distribution for the test set is generated. Coverage metric values to determine a correlation between the training activation diversity distribution and the test activation diversity distribution are identified.

The determining the coverage metrics values further includes determining coverage metric values representing the performance of the trained DNN. The determining the training centroid further includes determining training average patterns for layers of the DNN, and tensor multiplying the training average patterns for the layers of the DNN to determine the training centroid.

The applying the novelty metric to the output of the trained DNN based on the applied new data to identify the subset of the applied new data in response to determining whether the new features are generated further includes feeding the new data into the DNN, determining associated activation patterns induced by the new data. and determining OOD (Out-Of-Distribution) probability values representing a distance between the training centroid and values of the associated activation patterns induced by the new data. Based on the OOD probability values, a training activation diversity distribution induced by the new data is determined. Based on the training activation diversity distribution induced by the new data, determining the identified subset of the applied new data that generates the new features is determined.

In at least one embodiment, a device for improving robustness of a deep neural network (DNN) includes a memory storing computer-readable instructions, and a processor configured to execute the computer-readable instructions to apply a coverage metric to a trained DNN based on a test set to determine test set adequacy, and monitor a performance of the trained DNN. Based on the performance, new data is applied to the trained DNN. A novelty metric is applied to an output of the trained DNN based on the applied new data to identify a subset of the applied new data in response to determining whether new features are generated. The subset of the applied new data is identified.

The processor is further configured to remove the identified subset of the applied new data from a training set to be applied by the processor to train the DNN in response to the identified subset not generating a predetermined amount of the new features, and retain the identified subset of the applied new data in the training set to be applied by the processor to train the DNN in response to the identified subset generating the predetermined amount of the new features.

The processor is further configured to apply the coverage metric by training the DNN using a training set, generating a training activation pattern induced by the training set. and determining a training centroid based on the activation pattern induced by the training set. A first distance between the training centroid and values of the training activation pattern induced by the training set is determined. Based on the first distance, a training activation diversity distribution for the training set is generated. A test activation pattern induced by the test set is generated. A second distance between the training centroid and values of the test activation pattern induced by the test set is determined. Based on the second distance, a test activation diversity distribution for the test set is generated. Coverage metric values to determine a correlation between the training activation diversity distribution and the test activation diversity distribution are identified.

The coverage metric values represent the performance of the trained DNN. The processor is further configured to determine the training centroid by determining training average patterns for layers of the DNN, and tensor multiplying the training average patterns for the layers of the DNN to determine the training centroid.

The processor is further configured to identify the subset of the applied new data in response to determining whether the new features are generated by feeding the new data into the DNN, determining associated activation patterns induced by the new data, and determining OOD (Out-Of-Distribution) probability values representing a distance between the training centroid and values of the associated activation patterns induced by the new data. Based on the OOD probability values, generating a training activation diversity distribution induced by the new data is generated. Based on the training activation diversity distribution induced by the new data, the identified subset of the applied new data that generates the new features is determined.

In at least one embodiment, a non-transitory computer-readable media having computer-readable instructions stored thereon, which when executed by a processor causes the processor to perform operations including applying a coverage metric to a trained DNN based on a test set to determine test set adequacy, and monitoring a performance of the trained DNN. Based on the performance, new data is applied to the trained DNN. A novelty metric is applied to an output of the trained DNN based on the applied new data to identify a subset of the applied new data in response to determining whether new features are generated. The subset of the applied new data is identified.

The identified subset of the applied new data is removed from a training set to be applied to train the DNN in response to the identified subset not generating a predetermined amount of the new features. The identified subset of the applied new data is retained in a training set to be applied to train the DNN in response to the identified subset generating a predetermined amount of the new features. The applying the coverage metric further includes training the DNN using a training set, generating a training activation pattern induced by the training set, and determining a training centroid based on the activation pattern induced by the training set.

A first distance between the training centroid and values of the training activation pattern induced by the training set is determined. Based on the first distance, generating a training activation diversity distribution for the training set is determined. A test activation pattern induced by the test set is generated. A second distance between the training centroid and values of the test activation pattern induced by the test set is determined. Based on the second distance, a test activation diversity distribution for the test set is generated. Coverage metric values to determine a correlation between the training activation diversity distribution and the test activation diversity distribution are identified. The determining the coverage metrics values further includes determining coverage metric values representing the performance of the trained DNN.

The determining the training centroid further includes determining training average patterns for layers of the DNN, and tensor multiplying the training average patterns for the layers of the DNN to determine the training centroid. The applying the novelty metric to the output of the trained DNN based on the applied new data to identify the subset of the applied new data in response to determining whether the new features are generated further includes feeding the new data into the DNN, determining associated activation patterns induced by the new data, and determining OOD (Out-Of-Distribution) probability values representing a distance between the training centroid and values of the associated activation patterns induced by the new data. Based on the OOD probability values, generating a training activation diversity distribution induced by the new data is generated. Based on the training activation diversity distribution induced by the new data, the identified subset of the applied new data that generates the new features is determined.

The foregoing outlines features of several embodiments so that those skilled in the art better understand the aspects of the present disclosure. Those skilled in the art understand that embodiments described herein are used as a basis for designing or modifying other processes and structures for carrying out the same purposes and/or achieving the same advantages introduced herein. Those skilled in the art also realize that such equivalent constructions do not depart from the spirit and scope of the present disclosure, and that various changes, substitutions, and alterations do not depart from the spirit and scope of the present disclosure.

What is claimed is:

1. A method of improving robustness of a deep neural network (DNN), the method comprising:
applying a coverage metric to a trained DNN based on a test set to determine test set adequacy;
monitoring a performance of the trained DNN;
based on the performance, applying new data to the trained DNN;
applying a novelty metric to an output of the trained DNN based on the applied new data to identify a subset of the applied new data in response to determining whether new features are generated; and
identifying the subset of the applied new data.

2. The method of claim 1, wherein the identified subset of the applied new data is removed from a training set to be applied to train the DNN in response to the identified subset not generating a predetermined amount of the new features.

3. The method of claim 1, wherein the identified subset of the applied new data is retained in a training set to be applied to train the DNN in response to the identified subset generating a predetermined amount of the new features.

4. The method of claim 1, wherein the applying the coverage metric further comprises:
training the DNN using a training set;
generating a training activation pattern induced by the training set;
determining a training centroid based on the activation pattern induced by the training set;
determining a first distance between the training centroid and values of the training activation pattern induced by the training set;
based on the first distance, generating a training activation diversity distribution for the training set;
generating a test activation pattern induced by the test set;
determining a second distance between the training centroid and values of the test activation pattern induced by the test set;
based on the second distance, generating a test activation diversity distribution for the test set; and
determining coverage metric values identifying a correlation between the training activation diversity distribution and the test activation diversity distribution.

5. The method of claim 4, wherein the determining the coverage metrics values further comprises determining coverage metric values representing the performance of the trained DNN.

6. The method of claim 4, wherein the determining the training centroid further comprises:
determining training average patterns for layers of the DNN; and
tensor multiplying the training average patterns for the layers of the DNN to determine the training centroid.

7. The method of claim 1, wherein the applying the novelty metric to the output of the trained DNN based on the applied new data to identify the subset of the applied new data in response to determining whether the new features are generated further comprises:
feeding the new data into the DNN;
determining associated activation patterns induced by the new data;
determining OOD (Out-Of-Distribution) probability values representing a distance between the training centroid and values of the associated activation patterns induced by the new data;
based on the OOD probability values, generating a training activation diversity distribution induced by the new data; and
based on the training activation diversity distribution induced by the new data, determining the identified subset of the applied new data that generates the new features.

8. A device for improving robustness of a deep neural network (DNN), comprising:
a memory storing computer-readable instructions; and
a processor configured to execute the computer-readable instructions to:
apply a coverage metric to a trained DNN based on a test set to determine test set adequacy;
monitor a performance of the trained DNN;
based on the performance, applying new data to the trained DNN;
apply a novelty metric to an output of the trained DNN based on the applied new data to identify a subset of the applied new data in response to determining whether new features are generated; and
identify the subset of the applied new data.

9. The device of claim 8, wherein the processor is further configured to:
remove the identified subset of the applied new data from a training set to be applied by the processor to train the DNN in response to the identified subset not generating a predetermined amount of the new features; and
retain the identified subset of the applied new data in the training set to be applied by the processor to train the DNN in response to the identified subset generating the predetermined amount of the new features.

10. The device of claim 8, wherein the processor is further configured to apply the coverage metric by:
training the DNN using a training set;
generating a training activation pattern induced by the training set;
determining a training centroid based on the activation pattern induced by the training set;
determining a first distance between the training centroid and values of the training activation pattern induced by the training set;
based on the first distance, generating a training activation diversity distribution for the training set;
generating a test activation pattern induced by the test set;
determining a second distance between the training centroid and values of the test activation pattern induced by the test set;
based on the second distance, generating a test activation diversity distribution for the test set; and
determining coverage metric values identifying a correlation between the training activation diversity distribution and the test activation diversity distribution.

11. The device of claim 10, wherein the coverage metric values represent the performance of the trained DNN.

12. The device of claim 10, wherein the processor is further configured to determine the training centroid by:
determining training average patterns for layers of the DNN; and
tensor multiplying the training average patterns for the layers of the DNN to determine the training centroid.

13. The device of claim 8, wherein the processor is further configured to identify the subset of the applied new data in response to determining whether the new features are generated by:
feeding the new data into the DNN;
determining associated activation patterns induced by the new data;
determining OOD (Out-Of-Distribution) probability values representing a distance between the training centroid and values of the associated activation patterns induced by the new data;
based on the OOD probability values, generating a training activation diversity distribution induced by the new data; and
based on the training activation diversity distribution induced by the new data, determining the identified subset of the applied new data that generates the new features.

14. A non-transitory computer-readable media having computer-readable instructions stored thereon, which when executed by a processor causes the processor to perform operations comprising:
applying a coverage metric to a trained DNN based on a test set to determine test set adequacy;
monitoring a performance of the trained DNN;
based on the performance, applying new data to the trained DNN;
applying a novelty metric to an output of the trained DNN based on the applied new data to identify a subset of the applied new data in response to determining whether new features are generated; and
identifying the subset of the applied new data.

15. The non-transitory computer-readable media of claim 14, wherein the identified subset of the applied new data is removed from a training set to be applied to train the DNN in response to the identified subset not generating a predetermined amount of the new features.

16. The non-transitory computer-readable media of claim 14, wherein the identified subset of the applied new data is retained in a training set to be applied to train the DNN in response to the identified subset generating a predetermined amount of the new features.

17. The non-transitory computer-readable media of claim 14, wherein the applying the coverage metric further comprises:
training the DNN using a training set;
generating a training activation pattern induced by the training set;
determining a training centroid based on the activation pattern induced by the training set;
determining a first distance between the training centroid and values of the training activation pattern induced by the training set;
based on the first distance, generating a training activation diversity distribution for the training set;
generating a test activation pattern induced by the test set;
determining a second distance between the training centroid and values of the test activation pattern induced by the test set;
based on the second distance, generating a test activation diversity distribution for the test set; and
determining coverage metric values identifying a correlation between the training activation diversity distribution and the test activation diversity distribution.

18. The non-transitory computer-readable media of claim 17, wherein the determining the coverage metrics values further comprises determining coverage metric values representing the performance of the trained DNN.

19. The non-transitory computer-readable media of claim 17, wherein the determining the training centroid further comprises:
determining training average patterns for layers of the DNN; and
tensor multiplying the training average patterns for the layers of the DNN to determine the training centroid.

20. The non-transitory computer-readable media of claim 14, wherein the applying the novelty metric to the output of the trained DNN based on the applied new data to identify the subset of the applied new data in response to determining whether the new features are generated further comprises:
feeding the new data into the DNN;
determining associated activation patterns induced by the new data;
determining OOD (Out-Of-Distribution) probability values representing a distance between the training centroid and values of the associated activation patterns induced by the new data;
based on the OOD probability values, generating a training activation diversity distribution induced by the new data; and
based on the training activation diversity distribution induced by the new data, determining the identified subset of the applied new data that generates the new features.
